(19) United States
(12) Patent Application Publication
(10) Pub. No.: US 2016/0196595 A1
(43) Pub. Date: Jul. 7, 2016

(54) SYSTEM AND METHOD FOR SOLICITATON AND MANAGEMENT OF PROJECT SERVICES

(71) Applicant: Ramasamy Jagadeesh Sathayamangalam, Fair Lawn, NJ (US)

(72) Inventor: Ramasamy Jagadeesh Sathayamangalam, Fair Lawn, NJ (US)

(21) Appl. No.: 14/989,434

(22) Filed: Jan. 6, 2016

Related U.S. Application Data
(60) Provisional application No. 62/100,175, filed on Jan. 6, 2015.

(51) Int. Cl. G06Q 30/06; G06F 3/0484; G06F 3/0482

(52) U.S. Cl. CPC G06Q 30/0611; G06F 3/0482; G06F 3/04842

(57) ABSTRACT

A Smart Project Track system and method is designed to streamline various Project processes starting from submitting a project request through project completion and payment. The system facilitates communication between provider performing services and requester in need of services. The system permits quote submission, hiring provider, provider create task, manage task, project task implementation and tracking, requester approval of the project work, a payment process and feedback all in a form of workflow. The project workflow steps are customizable for each project types. Any Project Types, Category and sub category can be added by an Administrator. A project notification may be sent by email to a Requester and a Provider on each workflow steps. Also Requester and Provider can communicate through Comments on each steps.

### CROSS-REFERENCE TO RELATED APPLICATION

This application claims the benefit of priority of U.S. provisional application No. 62/100,175, filed Jan. 6, 2015, the contents of which are herein incorporated by reference.

### BACKGROUND OF THE INVENTION

The present invention relates to project management and, more particularly, to coordination of services between requesters, in need of services, and providers to provide needed services. Existing technology doesn't have capability to customize project flow, tracking project process start to finish. This flexibility lets Providers and Requester utilize application to submit request for any project types available and search for matching providers by location or by Category by Requester. The system User Interface will present screen view and workflow flow steps applicable to Project Types submitted by Project Requester. The Project Activity view will let users view Project details and action required. Also system project workflow step includes Provider to create Task and update status and completion of each task. After completion of all tasks an approval request sent to Requester for approval of tasks completed. After approved an invoice generated by Provider and requester can process payment through system or other means. A Dashboard view provides summarized view of current projects workflow steps, deals in local area and Providers list for Requester and A Provider Dashboard view provides summarized view of Payment summary, Reminders and Workflow steps to action by Provider.

As can be seen, there is a need for a solution to project management from start to finish for various project types for Requester to Request services and search for providers and track project and communicate effectively between Requester and Provider on services and process payments upon completion of services by Provider and feedback and quality of services for reviewing Provider reviews and quality of services thereof.

### SUMMARY OF THE INVENTION

In one aspect of the present invention, Smart Project Track stream line process starting from submitting a project request, communication between provider and requester. Search Provider by Location and Category or Category, Hiring provider, provider creating and project task implementation and tracking, customer approval of project work, payment process and feedback all in a form of workflow. The project workflow steps are customizable for each project types. System lets Provider and Requester communicate through the system on each step. Other functionality will let provider add new services in Sub category level, also in regional languages.

In one aspect of the present invention, the Smart Project Track provides project solicitation and management services and comprises: presenting a first user interface comprising one or more web pages presented on a first web browser a client device of a requester seeking performance of a project task, the user interface and web pages served by a host server; presenting a project solicitation tool on the first user interface, the project solicitation tool configured to present user controls and receive a plurality of inputs from the requester to select a plurality of predefined parameters defining the project task, the predefined parameters comprising a project type and a project category, wherein the project category parameters correspond to a selected project type; presenting a project details input control in the project solicitation tool to receive a detailed requester input further defining the project task; presenting a project submission control in the project solicitation tool, operable by the requester to transmit the project task; receiving the user inputs defining the project task on the host server in response to a user selection of the project submission control; presenting a quote request control operable by the requester to select at least one provider capable of performing the selected project type and project category; and receiving at the server, the defined project task as a request for quote.

In some aspects of the invention, the predefined parameters further comprise a project subcategory, corresponding to the selected project type, and a selected project category. The Smart Project Track may further comprise: automatically transmitting the request for quote to the at least one provider in response to receiving the requester activating a quote request control presented in the project solicitation tool UI. The Smart Project Track may also present a second user interface comprising one or more web pages presented on a second web browser of a second client device of the one or more providers; and present a quote preparation tool on the second user interface, the quote preparation tool is configured to present user controls and receive a plurality of inputs from the provider to select one a plurality of predefined quote parameters corresponding to the selected project type and the selected project category; present a quote submission control on the second user interface, operable by the provider to transmit the project task; receive provider inputs defining the quote on the host server in response to the provider selection of the quote submission control; and automatically transmit the quote to the requester via the host server upon receiving the provider's activation of the quote submission control.

In yet other aspects of the invention, the Smart Project Track may also comprise: presenting a quote selection tool on the first user interface, the quote selection tool comprising a listing of the quote transmitted to the requester; presenting a quote analysis control operable to view one or more performance parameters contained within the quote; and presenting a quote selection control operable by the requester to select a desired quote and hire the provider submitting the selected quote.

In other embodiments, the Smart Project Track may automatically apply a predefined workflow specifying an assignment of an action item to the provider and the requester based upon the predefined project type selected by the requester. The Smart Project Track may also automatically communicate a completion of the action item by transmitting a preformatted e-mail template corresponding to the workflow action item and populated with a user profile data element and a project task data element.

Other aspects of the present invention include a non-transitory computer-readable memory adapted for use by a host in serving web pages offering project solicitation and management services, the non-transitory computer-readable memory used to direct a server of the host to perform the steps of: presenting a first user interface comprising one or more web pages presented on a first web browser a client device of a requester seeking performance of a project task, the user interface and web pages served by a host server; presenting a project solicitation tool on the first user interface, the project solicitation tool configured to present user controls and receive a plurality of inputs from the requester to select a plurality of predefined parameters defining the project task, the predefined parameters comprising a project type and a project category, wherein the project category parameters correspond to a selected project type; presenting a project details input control in the project solicitation tool to receive a detailed requester input further defining the project task; presenting a project submission control in the project solicitation tool, operable by the requester to transmit the project task; receiving user inputs defining the project task on the host server in response to user selection of the project submission control; presenting a quote request control operable by the requester to select at least one provider capable of performing the selected project type and project category; and receiving at the server, the defined project task as a request for quote; and automatically transmitting the defined project task as a request for quote.

In come embodiments the non-transitory computer readable memory may further comprising directing the steps of: presenting a second user interface comprising one or more web pages presented on a second web browser of a second client device of the one or more providers; and presenting a quote preparation tool on the second user interface, the quote preparation tool configured to present a user control and receive a plurality of inputs from the provider to select one of a plurality of predefined quote parameters corresponding to the selected project type and the selected project category. The non-transitory computer readable memory of other embodiments may further direct the steps of: automatically applying a predefined workflow specifying an assignment of an action item for the provider and the requester based upon the predefined project type selected by the requester. The non-transitory computer readable memory may also direct the steps of: automatically communicating a completion of the action item by transmitting a preformatted e-mail template corresponding to the workflow action item and populated with a user profile data element and a project task data element.

In another aspect of the present invention, Stream lines finding a provider for your project needs, tracking the project start to finish and supports any project types including home improvement, software development to name a few. Project process is customizable for project types using Web/Mobile.

These and other features, aspects and advantages of the present invention will become better understood with reference to the following drawings, description and claims.

### BRIEF DESCRIPTION OF THE DRAWINGS

FIG. 1 is a representative system architecture of the Good Service Agent according to aspects of the present invention.

FIG. 2 is a flow chart of a provider registration process.

FIG. 3 is a flow chart of a member registration

FIG. 4 is a flow chart of a project type hierarchy creation.

FIG. 5 is a flow chart of the creation of a project description

FIG. 6 is a flow chart of a smart project track.

FIG. 7 is a flow chart of a project workflow process setup.

FIG. 8 is a flow chart of a provider deal offer.

FIG. 9 is a flow chart of a provider or member payment process.

FIG. 10 is a flow chart of the project questionnaire and response setup.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention, the Good Service Agent (GSA) system and method may be operated by a host to bring together a plurality of users, such Requesters and Providers, so that a Requester may develop one or more solicitations for a project. The Smart Project Track (SPT) component of the GSA system then provides project management of the projects from solicitation through completion, payment, and assessment.

Smart Project Track is designed to streamline various project management processes from the Requester's initiation and submission of a project request through project completion. The GSA and SPT facilitates communication between Providers and Requesters to provide clarity and uniformity in requesting and completing projects through the SPT. SPT enables a requester to hire a provider.

For the provider, SPT facilitates project task create task, update status, implementation and tracking, customer approval of project work, payment process and feedback all in a form of workflow. The SPT system provides a plurality of project workflow steps that are customizable for a plurality of project types, organized according to categories. Project workflows also permit a provider to add or further specify services at a Sub category level. Additional Project Types, Categories and sub categories can be added by a system Administrator. The system incorporates project notifications and updates sent by e-mail to Requesters and Providers on each workflow steps.

The flexibility of the SPT system permits Providers and Requester to utilize the system, either through a web portal or a mobile application to submit request for a plurality of project types available and permits Requesters to search for matching providers by Location range of requester and Category or by Category only (services subscribed by Provider and Requester).

Providers can register and subscribe to available services and service areas (if applicable) using the GSA Web or Mobile UI site. The system User Interface (UI) presents screen view and workflow flow steps applicable to a selected Project Type submitted by a project Requester. The system may also include a project activity view that permits users to view Project details and provide visibility for actions required.

A representative system architecture for the Good Service Agent (GSA) according to an embodiment of the present invention is illustrated in reference to FIG. 1. The system comprises a server hosting GSA Business Services Web API, including a GSA Model a GSA Repository, a GSA infrastructure, and a GSA Application Program Interface. A plurality of users, including the Requester in need of services and a Provider capable of providing the requested services may access the GSA Business Services via a network connection, such as the Internet, via a computing device. The users may access the GSA Business Services via a web based GSA Web User Interface (UI) or via a GSA Mobile Application hosted by the GSA Web Server. The GSA Model provides System domain entity objects. The GSA Repository provides a data layer to perform retrieve and save to SQL server database for the request by GSA Business Service layer. The GSA Infrastructure provides base object of reusable abstract objects inherited and implemented by GSA Model entity objects.

The GSA Business Services may send messaging and other correspondence via a send grid to provide e-mail services for users of the system. The system may also comprise Payment gateway services to process financial transactions between system users. The GSA Business Services may also have access to an internal or an external database, which provides services of get data request by UI layer, save data request to GSA Repository using GSA Data Service layer in secured manner.

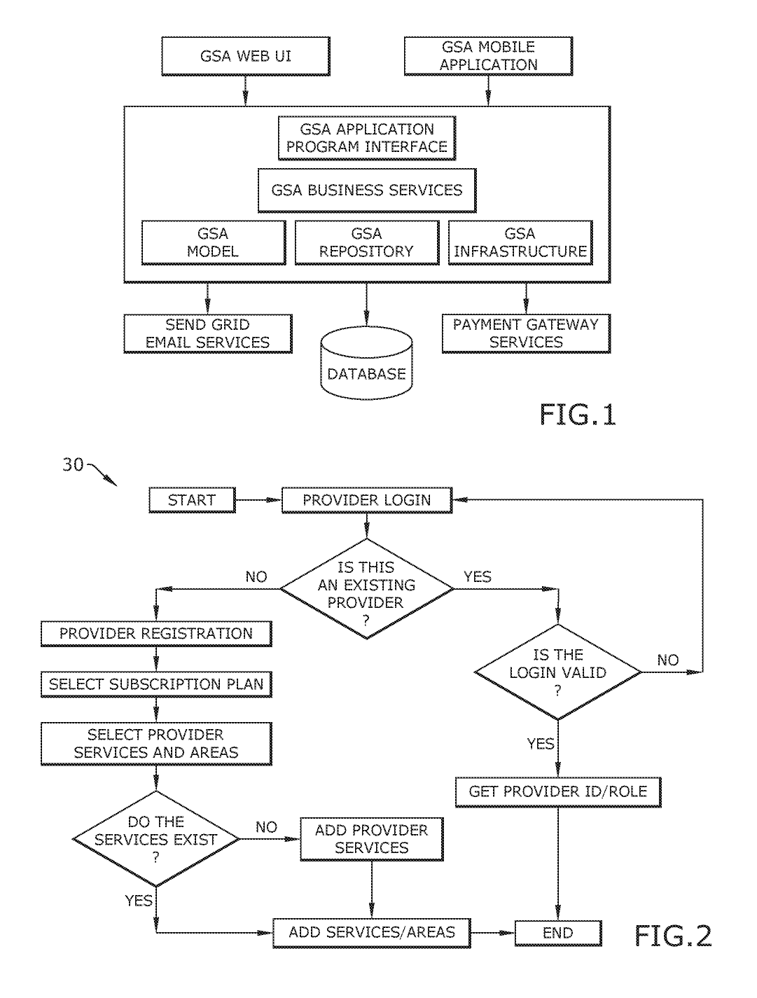

As seen in reference to FIG. 2, a provider registration process 30 is depicted. The Provider Login determines whether the provider is an existing, or subscribed provider with the system. If not, the provider is presented with a provider registration option. The registration allows the Provider to submit login info, a business profile, and demographic information, such as a contact person, a contact phone, a web site, a business address, and services offered and service areas for some project types, State license and date of expiry for license. The provider may also be presented with a selection option for enrolling in a provider subscription plan, and a provider specification option for indicating the services they provide, and optionally a provider service area. The provider is assigned a unique identifier and will be identified by a provider role.

After the provider has specified the services the provider is capable of performing, the system determines whether the specified services exist. If not, the system adds the specified provider services. If the specified services exist or they have been added, the provider may specify services areas in which the provider is willing to perform the services.

If the provider is an existing provider in the system, the provider's login is verified. Once verified, the provider's unique ID and role are retrieved.

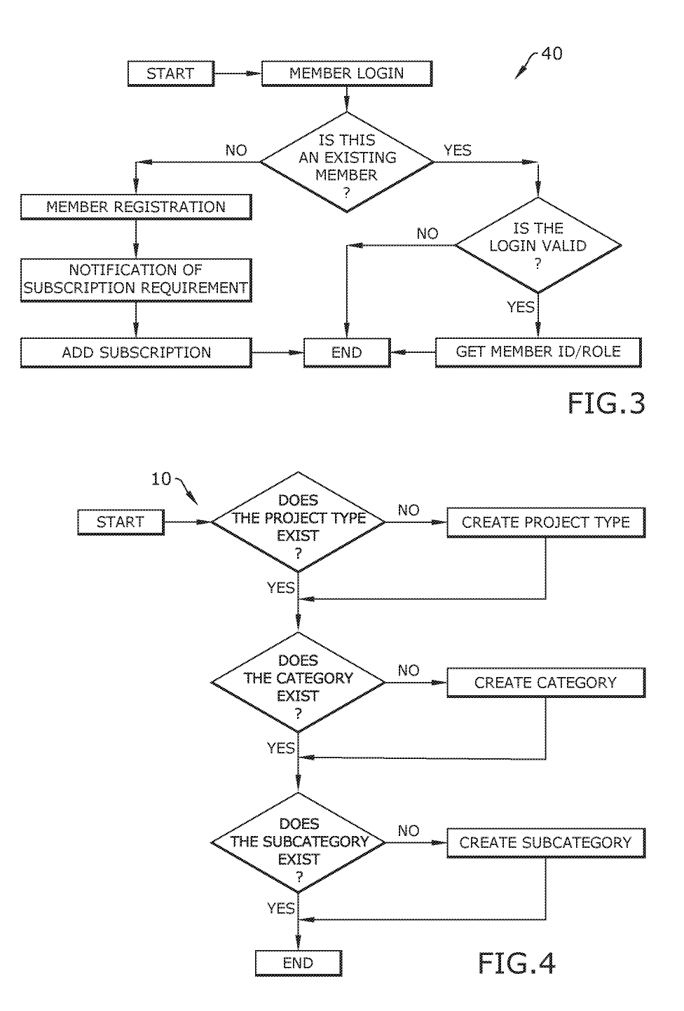

A similar Member Login process 40 is illustrated in FIG. 3 and is provided for Requesters. Users should be a registered member to utilize services. Members may also be prompted to provide input of personal and demographic information such as name, address, date of birth, user id, password and a security question to recover the password. Also some Project types may require the member to be a paid subscriber so members may need to choose project types and a subscription. The Requester is associated with a unique member ID and role within the system.

As seen in reference to FIG. 4, a representative project type hierarchy creation 10 process is presented. On input of a project type, the system determines whether the project type exists, if not one is created. If the type exists or is created, the system determines whether a category associated with the project type exists. If not one is created. The system may then determine whether a specified subcategory, corresponding to the specified category exists. If not one is created. In a preferred embodiment, this routine is accessible to a system Administrator.

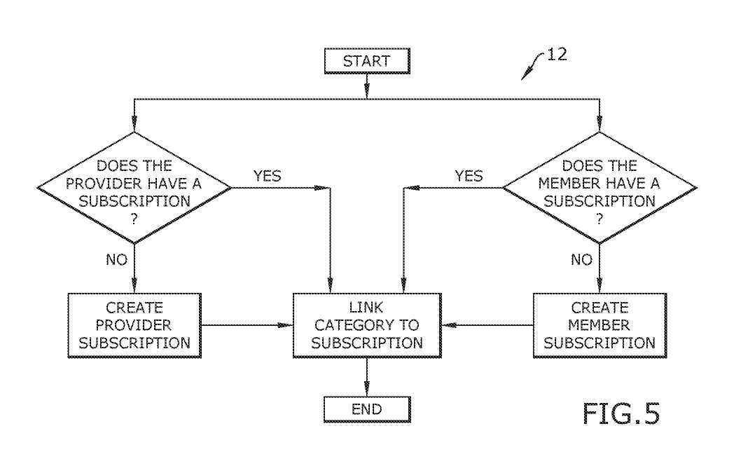

A flowchart for creating a project description process is illustrated in reference to FIG. 5. As indicated previously, user access to certain categories is controlled by a subscription system. If a user is interested in participating in a certain category, the user's selection of the category is verified against their subscription plan. If the user has a valid subscription the user is provided linked access to the selected category via the user's subscription. If the user doesn't have a subscription to the category, the user may subscribe and access the category via the subscribed category link.

Smart Project Track (SPT) Project Workflow

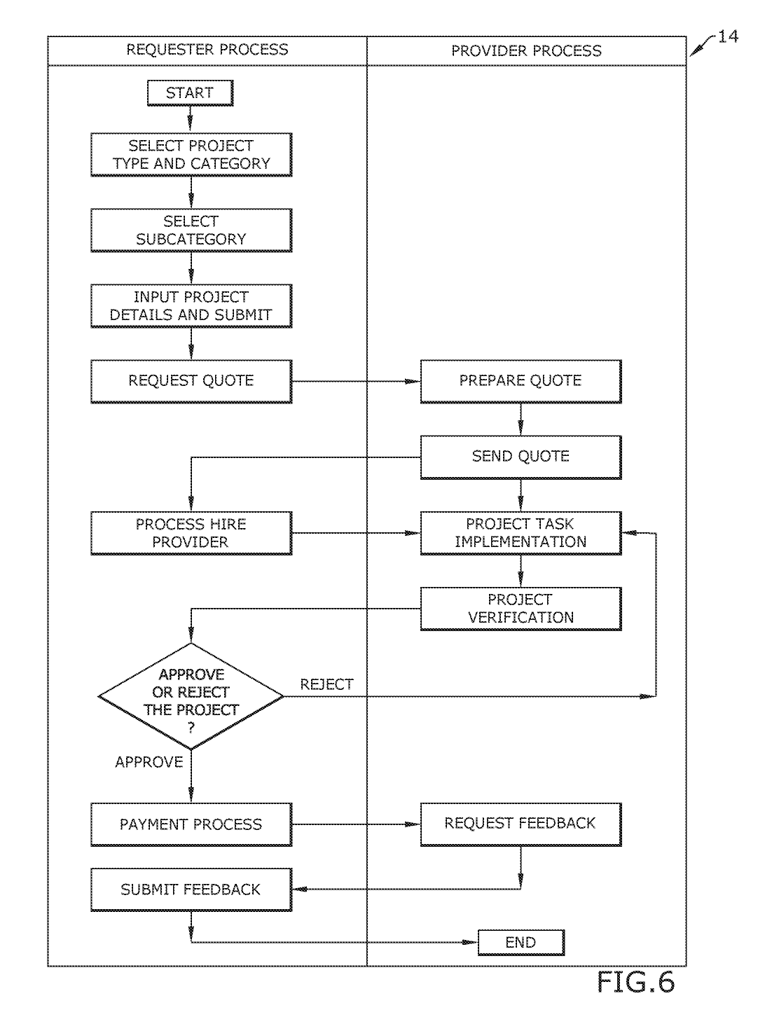

A flowchart of a Smart Project Track 14 is illustrated in reference to FIG. 6. The Smart Project Track process is conceptually divided by roles Service Requester Role, Service Provider Role and Admin Role, for example, those related to requester processes and those related to provider processes and Administrator role. The Smart Project Track flows from project initiation by a requester through project completion by the provider and approval by the requester. In some embodiments, the Smart Project Track 14 may include a Generate Invoice, payment process. In other embodiments, the Smart Project Track 14 may include a feedback process between the provider and the requester.

A Project workflow flow starts with Requester selecting a Project Type, a Category and, where provided a Sub Category that the requester is seeking to have performed. The selection options may be provided on the UI of the web browser or the mobile app. The UI may present the Project Type and Category via a dropdown selection of available Project Types, Categories, and Sub Categories. Alternatively, the project type selection options may be presented via a check box, radio box, or other selection control on the UI. In either case, the Categories corresponding to the selected Project Type may then be presented for the Requester's selection if at least a Provider subscribed to Category. Similarly, once the Requester has selected a Category, the Sub Categories associated with the Category may be presented in the UI. In some embodiments, the requester may further specify a Sub Category for the project request. In other embodiments, the UI may also provide an interface for the Requester to input additional project details and to submit a project request.

Once the Project Type and at least one Category is selected, however, the system generates each category as separate project workflow, the Requester may submit a project request as a request for a quote. The Requester may select the Provider of his choice or may opt to send the quote request to all Providers associated with the Project Type and Category and location range. Providers may be notified by email communication of the quote Request via the e-mail services.

On receipt of the request for quote, the Provider can input a quote description and specifications into the system via the provider UI to prepare a quote Proposal. When the Provider has completed the quote proposal, the Provider may transmit the quote proposal via the send grid e-mail services to the Requester.

Upon receipt of one or more quote proposals, the Requester may review and process the quote. To facilitate review and processing of the quote, the Smart Project Track system may permit the Requester to view the responding Providers profiles, compare quote proposals, accept a winning quote proposal, and to hire the selected Provider via the system e-mail services.

After hiring, the Smart Project Track system moves the project to a project task implementation. The project task implementation module is utilized by the Provider to integrate the awarded project task by creating task and managing task status with the providers existing project tasks. If not already established in the quote proposal, the provider may further specify a projected completion date of each task so that Requester as well as the Provider can track the Project status by viewing a task Dashboard, indicating a listing of tasks, a status of tasks, and a recent project activity of the Provider and Requester respectively. A Requester Dashboard may provide a summarized view of Project activity, a providers list, any deals or special discounts currently offered by providers and summary of active and closed projects. A Provider dashboard view may provide summarized view of a payment summary, deals or discounts offered by the provider and project activity of active projects. The dashboards may include links to a detailed view of the information presented in the dashboard.

After completing the task, a project verification module coordinates the verification and approval of the task performed. The Provider updates the task's completion status in the system. Once updated, the Smart Project Track communicates the Provider's indication that the project is complete to the Requester via the e-mail services.

Upon receiving the project completion notification, the Requester reviews the Requester's performance of the task and may either accept or reject the Provider's performance of the task. If rejected, the task is returned to the project task implementation module. The system permits the Requester to indicate performance standards that need correction to obtain approval. If the Requester approves the project task completion, the task may be marked as completed, that is the task has been performed.

In certain embodiments of the system, the Smart Project Track system will them proceed to Generate Invoice and payment process, in which the Requester's payment for the task is conveyed to the Provider. The payment process of the Smart Project Track system may be configured to receive a guarantee of the Requester's payment for the services as part of the subscription process. The payment process may be configured to credit the Provider's user account or may be configured for direct deposit to an account specified by the Provider as part of the provider's demographic data.

After the payment process has been completed, other embodiments of the system may include a feedback process in which the Provider may request a performance appraisal of the Provider's work Overall Rating, Price, Quality, Punctuality, Professionalism, service date, experience with provider, or specific portions thereof from the Requester. The feedback request is communicated via the Smart Project Track e-mail services. The feedback system may also include a Smart Project Track system feedback request that is sent to Requester. The system feedback request may be utilized by the system to provide requesters a system assessment of a provider's performance, which may be linked to the Provider's profile for use by other Requesters during their selection assessment Providers. This will complete the Project workflow, however, the system may be configured to have additional capabilities add more steps or include steps to reorder on Project Types.

Progress of a project through the Smart Project Track process may be visually displayed in a project workflow management view, which may also provide functionality so users can view and take action on project workflow steps. The workflow management view may also provide a workflow action button for action items that require a user response or action. For example, when the user has completed input of project details for a project, the workflow management view UI may present a submit button for the requester to activate to submit the project.

For workflows with sequential steps or processes, an action button for the current step in the process may be the only one presented, so as to maintain focus on that step or action. For workflows defined with parallel or concurrent tasks to be performed, in which some action may be needed from the requester and some action may be required by the provider, each may be provided an action button to indicate their completion of their respective tasks based on Requester owner role, Response role setup for the step. Request role can be Requester/Provider owner for current step, Response role is Requester/Provider role need to respond. When all concurrent or parallel tasks in the workflow have been completed, the workflow may then move on to a next step in the workflow, which may be either sequential or concurrent.

An additional feature of the Smart Project Track system is its ability to provide pre-configured workflows. Provider or Requester can view Project status and action required in Project activity screen or My Dashboard. Project workflow screen will let user's action on workflow step so the workflow step will be closed and moved to next step. Requester can click Approve to complete the step and move to next step or Reset start over the step.

Project Workflow Process

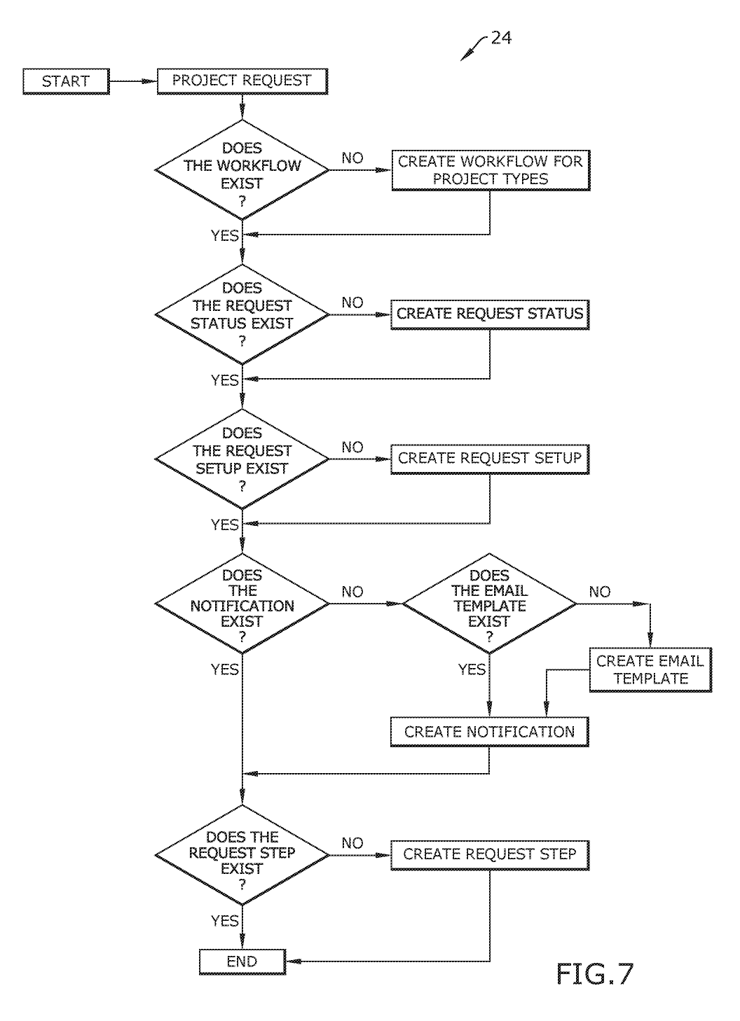

An embodiment of a project workflow process is illustrated in reference to FIG. 7. Project Workflow process 24 setup may be a Web based or mobile based Workflow Project process tracking system. The functionality lets a user, preferably a system administrator for the host, create any Project Type, Category, sub category and to configure Workflow steps based on the Project Type. Workflow functionality with combining Workflow, Request Setup in to specify the order of Request steps, level and grouping for each step.

At the request step, a workflow is requested. A workflow defines a sequence of steps or actions that are taken for completion of a specified project type, category, and, when specified, sub category. If the requested workflow does not exist, the requested workflow may be created for a project type. Preferably, the system administrator role will create request steps for Workflow functionality The workflow may be created, preferably by a system administrator.

If the workflow exists, the project workflow process checks to determine whether a request status of the workflow exists. A request status indicates or names a step of a workflow and may also include a description of the step. If the request status does not exist, the process allows the creation of a request status. If a request status exists, the process then determines whether a request setup exists.

A request setup, allows a user, preferably a System Administrator role, to create request setup code, that is, to specify parameters for the execution of a step in a workflow. The request setup may include an Initial state, a First state, a Last State and a Restart state for a request. The Initial state specifies an initial step for a Workflow step. The First state allows specification of a Workflow first step on user action. The Last state specifies the last step of the Workflow. This status completes the workflow step and moved to next step initial state. The Restart State permits the workflow to be restarted. If the state is not empty the workflow step can be re-initialized by Responsible owner role. If a request setup does not exist, the process flows to create a request setup. If a request setup exists, the process may then determine whether a request exists.

System administrator role may create Request steps for Workflow functionality with combining Workflow, Request Setup in following Request module, also the order of Request steps, level grouping for each step. The request may include a request name, a request sequence, and an initial request status. A requester role and a response role may be specified to indicate the sequence of the work flow between requesters and providers. A reminder period may be specified to send out a reminder to the appropriate user to prompt or remind that the user's action is required towards completion of the step. A completion period, such as due days, for completing the step may be specified. A request level may also be specified as well as an active status indicator. An action name for the request may be specified as well as the controller of the request. If a request does not exist, a request step is created. If a request step exist the project workflow process ends.

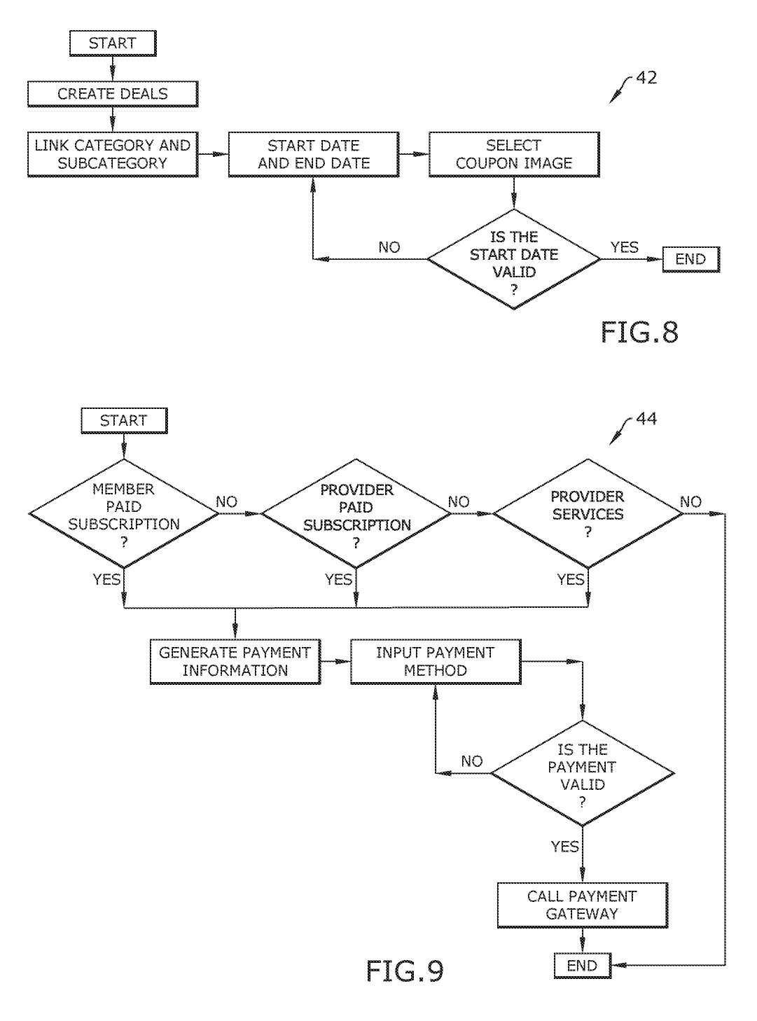

As briefly discussed with respect to the Provider Dashboard, a provider may offer deals or discounts to attract potential requesters. A deal offer process is illustrated in reference to FIG. 8. The deal offer process begins with the creation of a deal. The Provider may enter details of the deals via the UI. Once the Provider has created the deal, the Provider may link the deal to specific categories or subcategories for a selected project type in order to target requesters seeking services that the Provider performs. The Provider may then specify a start date and an end date during which the deal is to be made available. The process may also allow the Provider to select a coupon image. The deal offer process will then perform a validation to ensure that the selected offer period, such as the start date and end dates are valid. If the offer period is not valid, the process returns the provider to the start/end date step. If the offer period is valid, the process ends.

The workflows specified for a given project type, category, and, when utilized, a sub category are preferably configured to provide clarity and consistency in providing instructions to the requester and the provider via notification set up parameters. A notification setup specifies parameters for providing the form and content of a plurality of pre-formatted notification e-mail correspondence that may be sent by the Smart Project Track to the responsible role based on request's status in the specified workflow. The system Administrator role can create template emails for Request status and Workflow steps. A Smart Track Email Template provides function for Administrator can create email template for Notification setup or email template to be used for Requester or Member Profile change etc.

The template e-mails will contain fields that may be populated from a plurality of sources, which may include demographic data from the Requester and Provider Profiles, the project type, and a parameters specified workflow step. The pre-formatted notification e-mails provide clarity and consistency of instructions for the respective roles to take action on. The notification e-mails, project or workflow actions buttons, and other information pertaining to the progress and execution of the project may be retained for the system to provide the respective parties a common record of communications, specifications, and other information and events concerning the project.

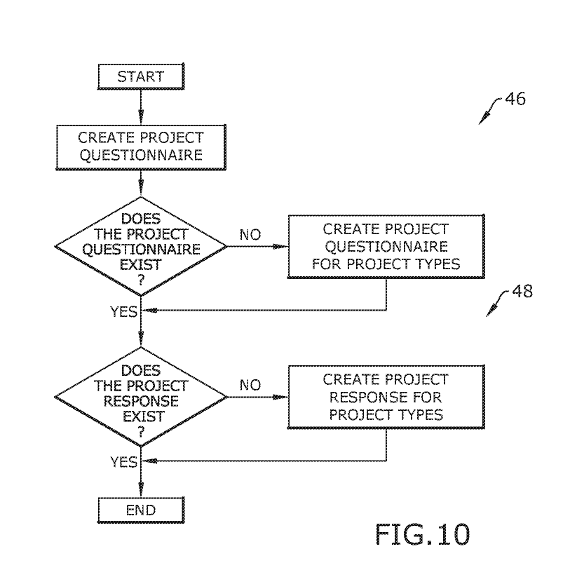

The system may provide further communications opportunities for each of the user roles through the presentation and interaction with Smart Protect Track Questionnaires. A process for questionnaires is illustrated in reference to FIG. 10. To create a project questionnaire, the system determines whether a project questionnaire exists. If not, the questionnaire may be created.

The questionnaires are preferably created by the System Administrator, and may be based on the selected project Type The questionnaire inputs and responses may be stored with the other system information to provide a permanent record of the transaction, while providing a common visibility of the questions and responses to the matters to both the Requester and Provider roles in Project details submission, the system allows up to 5 Project Questionnaire and Project Response for requester to select predefined values in drop down based on project type selected. The Project response can be free text or predefined selection from Drop down.

If a project questionnaire exists, the next step is to determine whether a project response exists. If no project response for a project type exists, the project response is created, again preferably by a system administrator of the host.

A Project Submit UI provides option for Requester to provide detailed Project Description, upload document to better understand the requirement of Project work to be performed and Project Questionnaire, Project response, Project status. Also the system Project Input User interface will be dynamically loaded based on Project Types selected. User cannot combine multiple Project Types on one submission of Project request.

As indicated previously, deals created through the process may be presented to requesters during the Smart Project Track process. For example, a deal may be presented during the select project type step to attract a Requester's attention to the discount and possibly entice selecting a project of that type that they may need, but have deferred due to costs. A deal may also be presented to the requester during the request quote step, to attract a Requester's attention and selection of the Provider of the deal to receive a request for a quote. A deal may also be presented to the requester during the hire provider stage, where a Requester's hiring decision may be influenced by the existence of a particular deal. A deal may also be presented as part of the payment or feedback process, to attract the Requester's attention to the Provider in a subsequent project for which the Provider provides services.

An embodiment of a provider or member payment process is illustrated in reference to FIG. 9. Invoice generated by Company Invoice UI view by administrator for Subscription services and Provider can generate Invoice for services provided to Requester. The payment process determines whether the user has paid or had a payment due for a member paid subscription, if not it determines whether the user has a provider paid subscription or whether a subscription payment is due. If the user does not have a provider paid subscription due the process then determines whether the user has received and approved provider services. If not, the payment process ends. If the user has payments due for one of a member subscription payment, a provider subscription, or approved provider services, the payment system generates payment information, such as an invoice with account information and any payments due. The user may then proceed to input a payment method. The payment method is then validated. If the payment method is not valid, the process returns for input or correction of the payment method information. If the payment is valid, the process calls the payment gateway to complete the payment transaction.

The system may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may also be accessed by the computer using a web browser. The computer may access the software via the web browser using the internet, extranet, intranet, host server, internet cloud and the like.

The computer-based data processing system and method described above is for purposes of example only, and may be implemented in any type of computer system or programming or processing environment, or in a computer program, alone or in conjunction with hardware. The present invention may also be implemented in software stored on a non-transitory computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

What is claimed is:

1. A method of providing project solicitation and management services, comprising:
presenting a first user interface comprising one or more web pages presented on a first web browser a client device of a requester seeking performance of a project task, the user interface and web pages served by a host server;
presenting a project solicitation tool on the first user interface, the project solicitation tool configured to present user controls and receive a plurality of inputs from the requester to select a plurality of predefined parameters defining the project task, the predefined parameters comprising a project type and a project category, wherein the project category parameters correspond to a selected project type;
presenting a project details input control in the project solicitation tool to receive a detailed requester input further defining the project task;
presenting a project submission control in the project solicitation tool, operable by the requester to transmit the project task;
receiving the user inputs defining the project task on the host server in response to a user selection of the project submission control;
presenting a quote request control operable by the requester to select at least one provider capable of performing the selected project type and project category; and
receiving at the server, the defined project task as a request for quote.

2. The method of claim 1, wherein the predefined parameters further comprise a project subcategory, corresponding to the selected project type, and a selected project category.

3. The method of claim 1, further comprising:
automatically transmitting the request for quote to the at least one provider in response to receiving the requester activating a quote request control presented in the project solicitation tool UI.

4. The method of claim 3, further comprising:
presenting a second user interface comprising one or more web pages presented on a second web browser of a second client device of the one or more providers; and
presenting a quote preparation tool on the second user interface, the quote preparation tool configured to present user controls and receive a plurality of inputs from the provider to select one a plurality of predefined quote parameters corresponding to the selected project type and the selected project category;
presenting a quote submission control on the second user interface, operable by the provider to transmit the project task; and
receiving provider inputs defining the quote on the host server in response to the provider selection of the quote submission control; and
automatically transmitting the quote to the requester via the host server upon receiving the provider's activation of the quote submission control.

5. The method of claim 4, further comprising:
presenting a quote selection tool on the first user interface, the quote selection tool comprising a listing of the quote transmitted to the requester;
presenting a quote analysis control operable to view one or more performance parameters contained within the quote; and
presenting a quote selection control operable by the requester to select a desired quote and hire the provider submitting the selected quote.

6. The method of claim 1, further comprising:
automatically applying a predefined workflow assignment of an action item to the provider or the requester based upon the predefined project type selected by the requester.

7. The method of claim 6, further comprising:
automatically communicating a completion of the action item by transmitting a preformatted e-mail template corresponding to the workflow action item and populated with a user profile data element and a project task data element.

8. A non-transitory computer-readable memory adapted for use by a host in serving web pages offering project solicitation and management services, the non-transitory computer-readable memory used to direct a server of the host to perform the steps of:
presenting a first user interface comprising one or more web pages presented on a first web browser a client device of a requester seeking performance of a project task, the user interface and web pages served by a host server;
presenting a project solicitation tool on the first user interface, the project solicitation tool configured to present user controls and receive a plurality of inputs from the requester to select a plurality of predefined parameters defining the project task, the predefined parameters comprising a project type and a project category, wherein the project category parameters correspond to a selected project type;
presenting a project details input control in the project solicitation tool to receive a detailed requester input further defining the project task;
presenting a provider search based on at least one of a location range and the project category;
presenting a list of tasks by Provider with a task status updated on completion based on Requester project description;
presenting a project submission control in the project solicitation tool, operable by the requester to transmit the project task;
receiving the user inputs defining the project task on the host server in response to a user selection of the project submission control.
presenting a quote request control operable by the requester to select at least one provider capable of performing the selected project type and project category; and
receiving at the server, the defined project task as a request for quote.
presenting a quote request control operable by the requester to select at least one provider capable of performing the selected project type and project category; and
transmitting the defined project task as a request for quote.

9. The non-transitory computer readable memory of claim 8, further comprising directing the steps of:
presenting a second user interface comprising one or more web pages presented on a second web browser of a second client device of the one or more providers; and
presenting a quote preparation tool on the second user interface, the quote preparation tool configured to present a user control and receive a plurality of inputs from the provider to select one of a plurality of predefined quote parameters corresponding to the selected project type and the selected project category.

10. The non-transitory computer readable memory of claim 9, further comprising directing the steps of:
automatically applying a predefined workflow assignment of an action item for the provider or the requester based upon the predefined project type selected by the requester.

11. The non-transitory computer readable memory of claim 10, further comprising directing the steps of:
automatically communicating a completion of the action item by transmitting a preformatted e-mail template corresponding to the workflow action item and populated with a user profile data element and a project task data element.
